(19) United States
(12) Patent Application Publication
(10) Pub. No.: US 2002/0004804 A1
(43) Pub. Date: Jan. 10, 2002

(54) Industrial automation system graphical programming language storage and transmission

(76) Inventor: Georg Muenzel, Plainsboro, NJ (US)

Correspondence Address: Siemens Corporation, Intellectual Property Department, 186 Wood Avenue South, Iselin, NJ, 08830, US

(21) Appl. No.: 09/822,300

(22) Filed: Mar. 23, 2001

Related U.S. Application Data
(60) Provisional application No. 60/192,147, filed on Mar. 24, 2000.

(51) Int. Cl. G06F 17/00

(52) U.S. Cl. 707/513

(57) ABSTRACT

Problems associated with handling industrial automation control code created using graphical programming languages, principally the absence of any standard storage format or any user-readable one, are addressed by providing methods and computer program products for storing industrial automation code generated using graphical programming languages in a format that permits human readability, is supported by available viewing technology (e.g., browsers), is easy and fast to parse, and that supports hierarchical information structures. The methods and computer program products according to the invention involve converting a program written in a graphical programming language and stored during execution in computer memory in a non-standardized internal binary representation into a mark-up language format, for example, the extensible mark-up language (“XML”), storing, transmitting, receiving and inspecting the program stored in this manner, and converting the stored program back into the graphical programming language internal representation.

### CROSS-REFERENCE TO RELATED APPLICATIONS

This application claims benefit from U.S. Provisional Patent Application Ser. No. 60/192,147, filed Mar. 24, 2000, under 35 U.S.C. § 119(e).

### FIELD OF THE INVENTION

The present invention relates generally to graphical programming languages for programmable logic controllers. In particular, the invention concerns a method and system for standardized storage of graphical programming languages.

### BACKGROUND

Graphical programming languages are widely used in the field of industrial automation. They provide an intuitive way for automation engineers to specify the control logic for an industrial control application to be run by a controller, usually a programmable logic controller (“PLC”). A PLC may comprise dedicated hardware or, alternatively, be implemented in software on a conventional personal computer, the latter being sometimes referred to as a PC-based PLC. The term PLC will be used here to describe either type of industrial controller.

Existing graphical programming systems for industrial automation control software typically provide a graphical editor that embodies features that are well-known in the context of text editing. Using a system of this kind, an automation engineer interacts with an editor to select icons from a menu in such a manner as to structure the control flow for the controlled industrial process, set conditions to be observed in that control, and so forth. The symbols available for use via the editor correspond to the particular graphical programming language being used, among which languages are: ladder logic, function block diagrams, sequential function charts and flowcharts, and languages if any embodying other formalisms. The graphical symbols depicted for the engineer by these editors are represented, when stored on a hard drive, for example, by the computer system on which the editor runs, in a private or internal binary form, here referred to as an “internal representation”, which is essentially a set of software objects that use volatile memory (RAM) (hereinafter referred to as “memory” or “computer memory”) and have associated code. This internal representation is specific or private to the software vendor, rather than being standardized.

When an industrial control program is deemed sufficiently complete to be debugged, or to be run on the PLC, the system compiles the internal representation to arrive at another binary form that is more readily usable by the PLC. In some systems, this compilation step is direct; in others, several layers of compilation are used for reasons unrelated to the present invention.

Some of the graphical programming languages in use today are the subject of international standards, such as are defined in IEC 61131. In contrast to textual programming languages, however, which can be stored in a computer file exactly as the user typed them (i.e., in a serialized form), there is no commonly agreed upon storage format for graphical programming languages. The representations used in existing graphical language programming systems for industrial control applications, moreover, are not generally human-readable. Nor are they are available in a format capable of being interpreted by a browser, such as Internet Explorer 5, or one that is easily or quickly parsed.

The known ways of attempting to address these shortcomings have involved the use of one or another binary format, which has the disadvantage of being private and unreadable with a standard word-processor. Alternatively, a proprietary text format, while capable of being more readable, must be fully defined. That is, it must be shown to follow the rules of a programming language (“grammar”). In order to understand such a program after reading it from a file, a full-blown parser must be written. These shortcomings have limited the utility of programs created using graphical programming systems and placed constraints on the process of developing control programs.

### SUMMARY OF THE INVENTION

The present invention is directed at overcoming the shortcomings of existing industrial automation graphical programming systems described above by providing methods and computer program products for storing graphical, industrial automation programs in a standard format, one that is serialized, relies on a text-based language (i.e., a mark-up language), includes tags or analogous functionality for identifying items, and that has as the ability to describe data hierarchically. More specifically, the present invention provides a mechanism that is standardized, readable by a human, supported by existing browser technology (e.g, Microsoft Internet Explorer 5 s (“IE5”)), is easy and fast parsing, and that supports hierarchical information structures.

The present invention also provides methods, systems and computer program products that permit industrial automation control programs, once created in whole or in part, to be transmitted over a network in an easily-displayed and apprehended form. The program code stored in this standard, readable form can be transmitted over a network to, or received from, a plurality of computer systems. In addition, markup language schemas (or analogous definitions) describing content models for markup language files generated by graphical programming language applications can be made available to a plurality of developers by posting, for example, on an internet site. This approach is intended to permit, among other advantages, distributed generation of industrial automation program code or applications.

In addition, or alternatively, code generated by a first system employing a first internal representation of code generated by a graphical programming language can be converted to the markup-language (e.g., XML) format, transmitted to a second system employing a second internal representation of the code, and there be reconverted to the second internal representation. The present invention, in this embodiment, is thereby capable of providing interoperability between systems.

Accordingly, an embodiment of the present invention provides a method for representing industrial automation computer program code created using a graphical programming language tool that stores the created code in computer memory in an internal representation during execution. The method comprises the steps of identifying industrial automation code in computer memory in the internal representation and converting the code from the internal representation to a markup language format.

Another embodiment of the present invention involves a computer program product used in conjunction with a computing device for creating industrial automation system control program code with a graphical language programming tool and storing the code in a computer memory in an internal representation during execution. The computer program product comprises a computer usable medium comprising computer readable program code for identifying industrial automation system control program code stored in computer memory in the internal representation. The computer program product further comprises computer readable program code for converting the identified industrial automation control program code from the internal representation to a markup language format.

A further embodiment of the present invention involves a computer program product that comprises a computer-readable storage medium and has data stored on it that comprises a representation of industrial automation control code formatted in markup language.

Another embodiment of the present invention relates to a computer program product for permitting a user to create industrial automation control programs. The product comprises a computer-readable storage medium having computer program code stored on it. The computer program code comprises industrial automation graphical programming language code. The graphical programming language code comprises an editor adapted to permit the user to create industrial automation control code using graphical elements, the control code being stored in memory in an internal representation during execution; and computer program code for converting industrial automation control code, stored in memory in the internal representation, from the internal representation to a markup language format.

In another embodiment of the present invention, a method is provided for communicating the logical structure of industrial automation control program data to permit a plurality of application developers to create applications relating to the data. The method comprises the steps of creating a schema defining a content model for markup language files generated by an industrial automation control program system and posting the schema for access over a network by the application developers.

Still further, an embodiment of the present invention entails a method for providing industrial automation control code from a server system over a network to which the server system is coupled and to a client system also coupled to the network. The method comprises the steps of accessing a markup-formatted version of the control code and transmitting the accessed, markup-formatted control code over the network in connection with a network address corresponding to the client system, thereby causing the transmitted, markup-formatted control code to be received by the client system.

Yet another embodiment of the present invention relates to a method for programming industrial automation control applications comprising the steps of providing a computer system coupled to a network, configuring the first computer system to receive over the network transmissions of data from a plurality of industrial automation program developer systems, and receiving data from the plurality of industrial automation program developer systems program code in a markup language format.

### BRIEF DESCRIPTION OF THE DRAWINGS

FIG. 1 provides, in schematic form, an illustration of an embodiment of the computer program product according to the present invention in the context of an industrial automation control system that includes an industrial automation control programming system.

FIG. 2 provides, in schematic form, an illustration of an embodiment of a conversion process according to the present invention.

FIG. 3 provides an illustration of an object model for an internal representation of a flowchart which, according to an embodiment of the present invention, is to be converted into a markup format.

FIG. 4 provides an illustration of an object model for an internal representation of a flowchart body (corresponding to the flowchart object model of FIG. 3) which, according to an embodiment of the present invention, is to be converted into a markup format.

FIG. 5 provides an illustration of an object model for an internal representation of a flowchart interface (corresponding to the flowchart object model of FIG. 3) which, according to an embodiment of the present invention, is to be converted into a markup format.

FIG. 6 provides an illustration of an embodiment of a system for deploying computer program product according to the present invention and for performing an embodiment of one or more methods according to the invention.

### DETAILED DESCRIPTION OF THE INVENTION

The various embodiments of the invention briefly described above, and set forth in the appended claims, are described below with reference to the figures, as well as to the code provided at the end of the text.

The present invention is directed to the creation of a standard, human-readable, preferably browser-readable representation of otherwise non-standardized representations of graphical programming language code for industrial automation. In a presently preferred embodiment of an aspect of the invention, XML is used as a standard storage format. XML, short for “the Extensible Markup Language”, is a subset of the Standard Generalized Markup Language (“SGML”) and is, essentially, a set of rules for defining a text based markup language. See, for example, XML lE5 Programmer's Reference, by A. Homer, WROX Press Ltd., 1999 and Applied XML: A Toolkit for Programmers, by A. Ceponkus and F. Hoodbhoy, John Wiley & Sons, Inc., 1999, the contents of which are herein incorporated by reference in their entirety. The invention is not limited to the use of XML, but can also be embodied with other markup languages corresponding to the definition set forth below

Moreover, the present invention can be practiced using Microsoft Visual Studio 6.0, as well as Microsoft XML (available as part of Internet Explorer 5).

For each graphical language used in the field of industrial automation, a set of XML tags, elements and attributes, as well as an XML schema (or document type definition “DTD”) are defined. A specific computer program, an example of which is described below for the conversion of a flowchart program to XML, is used to transform, convert or serialize the graphical program.

A number of terms frequently used in this document are defined below.

The term “data storage device,” as used here, refers to any medium is for the computer-retrievable storage of data including, without limitation, memory (e.g., RAM), hard disk, compact disk, floppy disk, or other storage device.

The term “computer program product”, as used here, includes any product capable of retaining data that may include computer program code and that can be permanently or temporarily coupled to a computer system that can retrieve data from the computer program product. Computer program products include media that are sold to users of computer systems so that the computer systems can operate in accordance with content stored on them. The term also encompasses hardware coupled to a computer system onto which content has been downloaded, for example, over a network, so that the computer system can operate in accordance with that content.

The term “editor command”, as used here, encompasses any command typically associated with known editors and involving the manipulation of text, code or the like, the commands including, for example, cut, copy, paste, move, delete, save, save as, undo, redo, and so forth.

The term “graphical programming language”, as used here, includes ladder logic, function block diagrams, sequential function charts and flowcharts and other graphical languages, whether now in existence or yet to be developed.

The term “markup-formatted”, as used here, refers to the state of having been stored in a markup language format or having been converted (e.g., from a graphical programming language internal representation) to a markup language format (markup being used in the sense defined above).

The term “markup language”, as used here, refers to text-based mark-up languages including but not limited to those that are subsets of the Standard Generalized Markup Language, SGML, which use elements that comprise a string of characters, including an individual character string that defines the opening or closing part of the element (corresponding to the term “tag” in XML usage), a name and value pair enclosed within the element's opening character string or tag, the element attribute names and their values, the content of the element and any closing tag, a character string that defines the opening or closing part of an element

The term “network” refers, in a preferred embodiment of the invention, to an internet, but also encompasses any type of data communication network, whether wired or wireless.

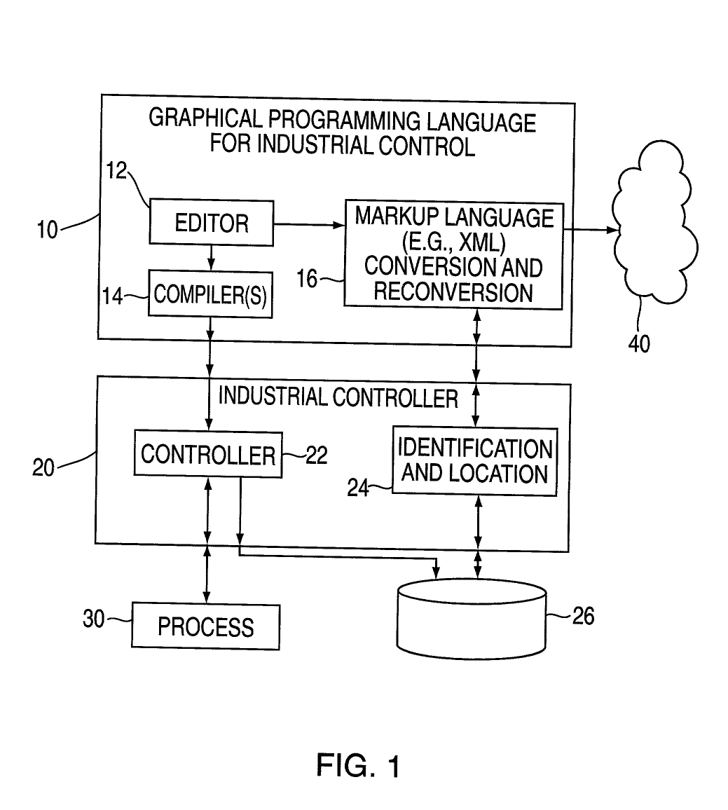

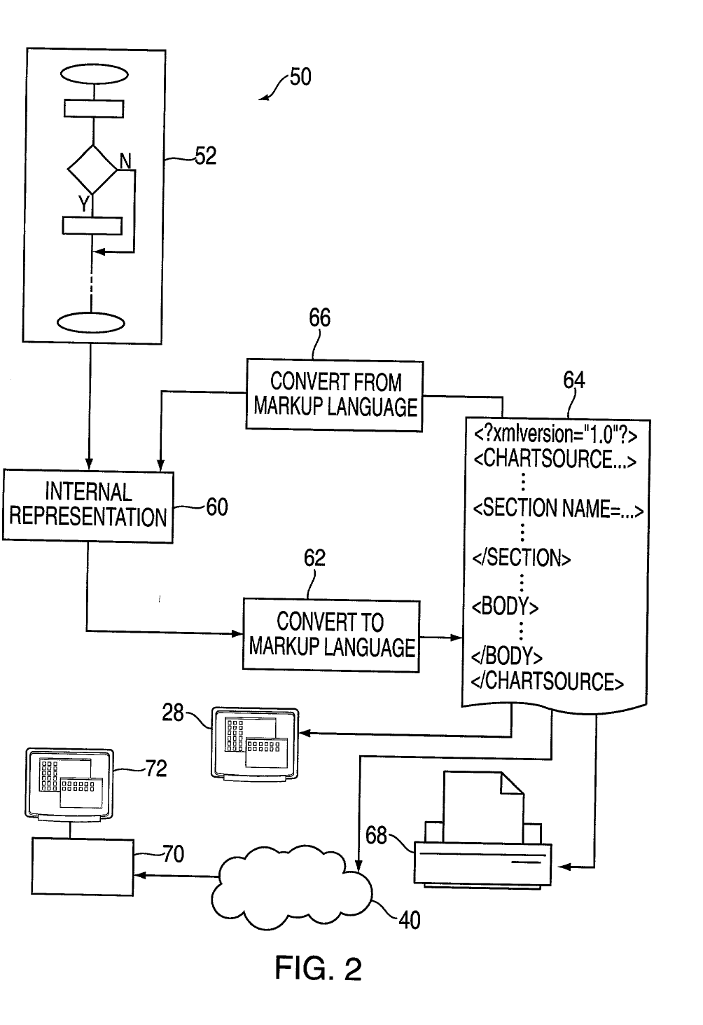

An embodiment of the computer program product according to the present invention is shown in schematic form in FIG. 1. In that figure, the computer program product is depicted in the context of an industrial automation control system, including an industrial automation control programming system 10, an industrial controller system 20 and a controlled process 30. Industrial controller system 20 may be a PLC that is separate hardware from the computer on which the programming system 10 runs; alternatively, industrial controller system 20 and programming system 10 could be implemented on the same computer device (e.g., embodying what is often referred to as a “PC-based PLC”). The typical programming system, which nowadays allows an industrial automation engineer to program with graphical tools (flowchart elements, for one of several examples), includes an editor 12. Editor 12, when operated by an automation engineer, graphically displays, in whatever formalism it uses, the program created by the engineer. At the same time, it causes the creation and storage in a computer memory of an internal representation (as elaborated upon in FIG. 2 and the accompanying text).

The control programming system 10 (one example of which is Step 7®, developed and marketed by Siemens A.G. and Siemens Energy & Automation, Inc.) also may include are one or more compilers 14, which convert, either directly or indirectly, the internal representation created using the editor 12 into a form that is understandable by the controller 22 of industrial controller system 20. Using the compiled result, and based also on clock data (not shown) and on input received from controlled process 20, controller 22 generates control instructions for running process 30. In s addition, the compiled code understandable by controller 22 can be stored on data storage device 26, that is coupled to (or is part of) industrial controller 20.

Another component of programming system 10, according to an embodiment of the present invention, is a converter 16 for converting the internal representation of control programs generated by editor 12 to a markup language format (e.g., XML). The operation of converter 16 is elaborated upon below in connection with FIG. 2 and in the appended source code. The markup language formatted code generated by converter 16 can be stored either on data storage device 26, with assistance of identification and location program code 24 running on industrial controller 20, or, alternatively, can be transmitted to network 40 and, via that network, to other systems (not shown).

FIG. 2 provides, in schematic form, an illustration of the steps according to an embodiment of a method 50 according to the present invention. A sample of a flowchart program 52 (e.g., generated by editor 12 of FIG. 1) is given an internal representation 60 that is usually in binary format, which is held in memory (RAM) (not shown) during execution of the program. The internal representation 60 is, in general, specific to the vendor of the graphical programming language system 10, is not readable by a human, is not readable using a word-processor, nor using a browser.

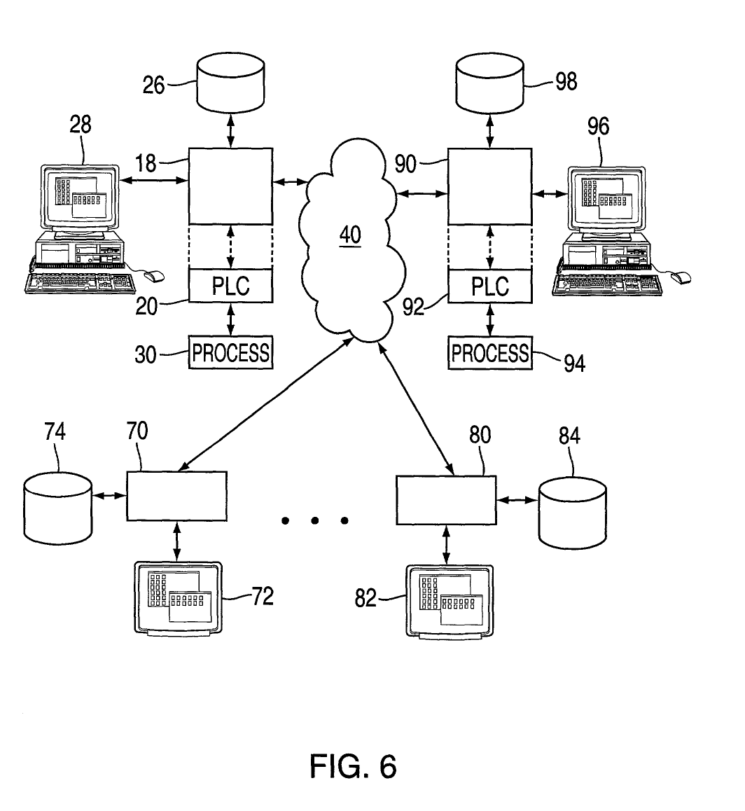

The internal representation is converted (or “serialized”) into the format of a suitable markup language (as set forth in the corresponding definition, above). Once converted, the graphical program is available in a markup-formatted form 64 (an example of which embodying XML is shown in FIG. 2) and can be stored (e.g., in data storage device 26 of FIG. 1 and FIG. 6). This markup-formatted form 64 of the graphical programming language code, originally represented at 52, can be sent directly to a monitor or display 28, where it can be viewed with known viewing software, including word processing or browser software. It can also be sent to printer 68, to create a human-readable hardcopy. Alternatively, it could be sent over a network 40 to another computer 70, which may have an associated interface 72. Computer 70 could be devoted, for example, to permitting development of control programs, which can then be converted and transmitted or retransmitted (although not necessarily in that order) to an industrial controller 20, programmed using graphical programming language system 10, where it can then be deployed.

When it becomes necessary to edit or compile an industrial automation program code that is already in markup format, at reference numeral 64, the markup-formatted code 64 is converted back (or “deserialized”) from markup language representation to the internal representation 60 (see, e.g., source code appended below).

The steps of the method of FIG. 2 may be invoked any time it is convenient or necessary to store or view, or to transmit to others for storage or viewing, a graphical industrial control program in a standardized representation. For example, any time an item is selected using an editing function, such as drag and drop, copy, cut, paste, undo, redo, etc., the conversion can be performed, creating a markup language (e.g., XML) string in memory that can be placed, for example, on a clipboard for transfer elsewhere. If a “save” were to be done to a graphical industrial automation program, or part of one, it would be converted, at 62, to markup format (e.g., XML) and saved in a file, for example, on storage device 26 of FIG. 1. Upon file “open” command being invoked relative to that stored, markup-formatted file, the file would be read and converted, at 66, back to the internal representation.

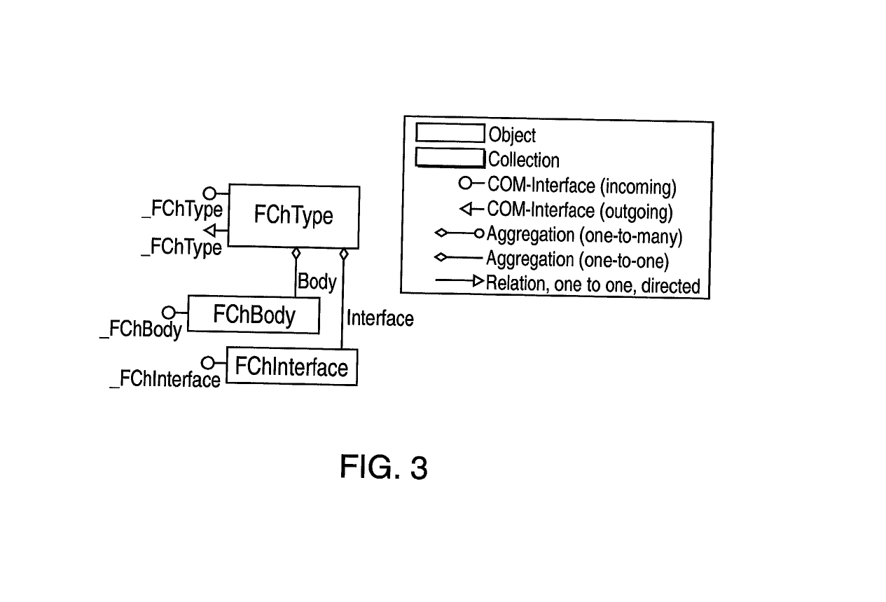

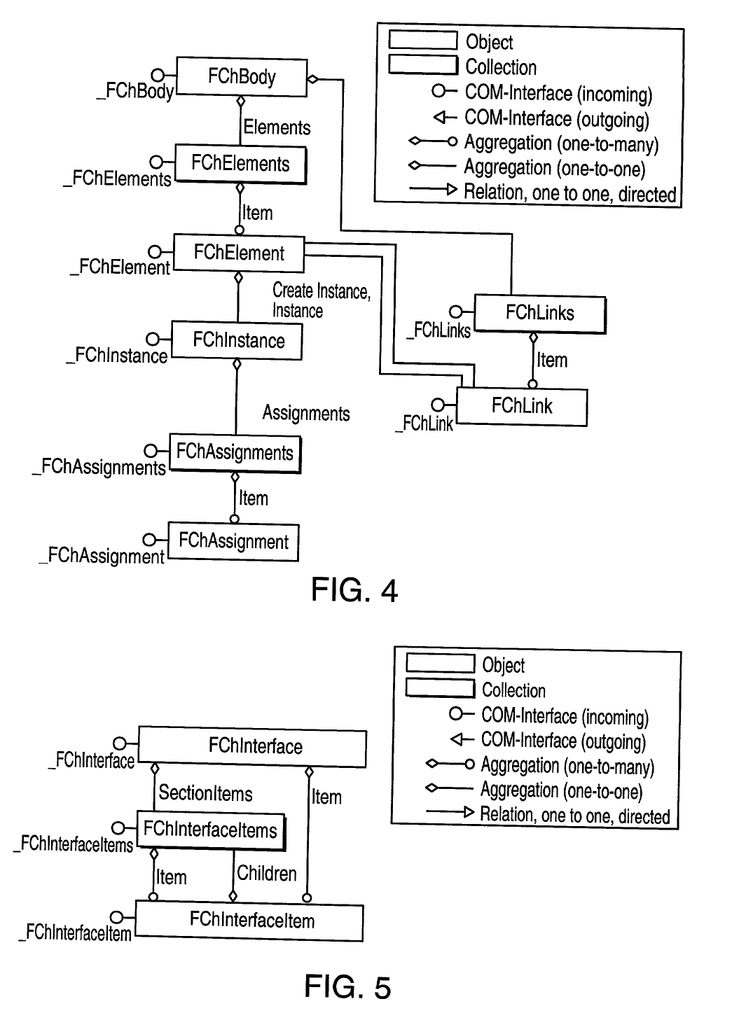

FIG. 3 provides an illustration of an object model for an internal representation of a graphical programming language formalism. As in FIG. 2, reference numeral 52, a flowchart formalism, is used for purposes of illustration. The corresponding internal representation, reference numeral 60 in FIG. 2, is to be converted into a markup format. This object model, of flowchart type (FChType) may, like the other object models, be implemented using COM (“Common Object Model”) technology, available from Microsoft Corp., or other suitable tools (See Class FChType, in the appended source code, below). Object FChType includes within its structure a flowchart body object, FchBody, and an interface object, Fchinterface, both in a one-to-one aggregation relationship with object FChType. (See legend in FIG. 3). FIG. 4 provides an illustration of an object model for an embodiment of the present invention, specifically focusing on an object model of a flowchart body, FChBody corresponding to the object model illustrated in FIG. 3. Body object FChBody stands in a one-to-one aggregation relationship to a flowchart elements object, FChElements, as well as with a flowchart links element, FChLinks, the latter being in a one-to-many aggregation relationship with a flowchart link element, FCHLink. FChElements, in turn, stands in a one-to-many aggregation relationship with one or more FChElement instances, each of which is related FChLink. A FChLink object connects 2 FChElement objects, a SourceElement to a TargetElement.

Each FChElement stands in a one-to-one aggregation relationship with an FChlnstance object, which in turn stands in a one-to-one aggregation relationship with a FChAssignments object. Each FChAssignments object stands, in turn, in a one-to-many aggregation relationship with one or more FChAssignment objects.

FIG. 5 provides an illustration of an object model for an embodiment of the present invention, specifically focusing on an object model of a flowchart interface, corresponding to the object model illustrated in FIG. 3. The FChinterface object stands in a one-to-one aggregation relationship with FChinterfaceltems object, and in a one-to-many relationship with the FChinterfaceltem. Moreover, FChinterfaceltems object is in a one-to-many FChlnterfaceltem object.

Referring again to FIG. 2, the internal representation 60, described above in connection with FIGS. 3, 4 and 5, is converted at reference numeral 62 to a suitable markup language format, for example XML. See the commented source code, below, for further detail.

FIG. 6 provides an illustration of an embodiment of a system for deploying computer program product according to the present invention and for performing an embodiment of one or more methods according to the present invention. An industrial automation programming and control system 18, which can include or incorporate a PLC 20 (as shown by the dotted lines) is coupled to a display 28, to at least one data storage device 26 and to a controlled process 30. In addition, it is coupled to a network 40, over which it can communicate with other computers also connected directly or indirectly to the same network 40. For example, industrial automation programming and control system 18 can be in communication over network 40 with a remote computer 70 having a display 72 and data storage device(s) 74, or with a plurality of such computers, one of which is shown at reference numeral 80, also having a display 82 and data storage device(s) 84.

By using the conversion approach shown in FIG. 2 and described in the accompanying text, not only can markup-formatted code be easily viewed at the site where it was created, but can easily be sent over a network 40 to another computer 70, where an operator may, using display 72, readily examine the code on the display, using a browser, for example. If the operator were an industrial automation controls engineer or developer of industrial automation control code, that operator could generate program code on computer 70 that could subsequently be converted to markup format and transmitted or re-transmitted (although not necessarily in that order) to an industrial automation programming and control system 18 or controller 20. The same could be done using computer 80, or via any number of computers in communication over network 40 with automation programming and control system 18.

Communications over network 40, preferably although not necessarily an internet, between various involved computers depicted in FIG. 6 can be done in any suitable manner including, without limitation, via downloading of pages using hypertext transfer protocol, or even via sending electronic mail messages.

Given this configuration, in an embodiment of an aspect of the present invention, computer 70 could be considered an industrial automation control code server system coupled over a network to a client system 18. Computer 70 accesses a markup-formatted version of the control code, transmits the accessed, markup-formatted control code over the network in connection with a network address corresponding to system 18, thereby causing the transmitted, markup-formatted control code to be received by the client system. Moreover, system 18, in response to the received markup-formatted control code, may transmit to computer 70 over the network 40 data relating to the automation to which the markup-formatted control code is directed. Furthermore, computer 70 can generate or otherwise access control code modified in response to receipt of the data from system 18, wherein the modified control code is markup-formatted. In addition, the markup-formatted, modified control code can be transmitted over the network in connection with a network address corresponding to the system 18, thereby causing the transmitted, modified, markup-formatted control code to be received by the system 18. FIG. 6 depicts an embodiment of another aspect of the present invention involving a method for communicating the logical structure of industrial automation control program data to permit a plurality of application developers to create applications relating to the data. According to the method, a schema (or analogous data) (see source code for an example schema appended below) defining a content model for markup language files generated by an industrial automation control program system (e.g., XML) is posted for access over network 40 (e.g., internet). Application developers using, for example, computers 70, 80 and 90, can then access and understand the logical structure of the graphical programming language data and can write their own applications. Developers and systems that communicate with one another using the standardized format according to the present invention need not use identical internal representations 60 of the automation system control code, provided that their conversion program takes into account the particulars of the internal representations 60 they do use.

FIG. 6 also describes a system in which a method for providing industrial automation control code services can be implemented. Assuming computer 70 can be considered a server running software permitting the creation of markup-formatted industrial automation control code (e.g., reference numeral 62 of FIG. 2), computer 70 can access such a markup-formatted version of the control code and transmitting the accessed, markup-formatted control code over the network 40 to a client system, for example, computer 18 in connection with a network address corresponding to computer 18, thereby causing the transmitted, markup-formatted control code to be received by the client system 18.

Client system 18, which (possibly along with PLC 20), controls process 30, may, in response to receiving the markup-formatted control code (e.g., reference numeral 62), may transmit to the server system 70 data relating to the automation to which the markup-formatted control code is directed. Server system 70 may modify code it is generating or has generated and, where it has access to automation system control code modified in response to receipt of system data from the client system 18, it may transmit the markup-formatted, modified control code over the network in connection with a network address corresponding to the client system 18, thereby causing the transmitted, modified, markup-formatted control code to be received by client system 18.

In another embodiment of the present invention, the foregoing method may involve a second client system 90 coupled to the network. Server 70 would transmit the accessed, markup-formatted control code (62, FIG. 2) over network 40 in connection with a network address corresponding to the second client system 90, thereby causing the transmitted, markup-formatted control code to be received by the second client system 90.

In yet another embodiment of the present invention, which demonstrates the potential for increased interoperability of systems, the first client system 18 may be configured to reconvert the markup-formatted control code to a first internal representation, while the second client system 96 is configured to reconvert the markup-formatted control code to a second internal representation.

Finally, FIG. 6 also is directed to a method for programming industrial automation control applications using a plurality of distributed applications developers. A computer system 18 is provided and coupled to a network 40 and configured to receive over the network 40 transmissions of data from a plurality of industrial automation program developer systems 70, . . . , 80, the transmissions comprising data from program developer systems 70, . . . , 80, in a markup language format.

In addition to the embodiments of the aspects of the present invention described above and in the XML schema and source code listings set forth below, those of skill in the art will be able to arrive at a variety of other arrangements and steps which, if not explicitly described in this document, nevertheless embody the principles of the invention and fall within the scope of the appended claims.

What is claimed is:

1. A method for representing industrial automation computer program code created using a graphical programming language tool that stores the created code in computer memory in an internal representation during execution, the method comprising the steps of:
identifying industrial automation code in computer memory in the internal representation; and
converting the code from the internal representation to a markup language format.

2. The method according to claim 1, comprising the further step of causing the converted, markup-formatted code to be stored in a computer data storage device.

3. The method according to claim 1, further comprising the step of transmitting the markup-formatted code over a network to a receiving computing device.

4. The method according to claim 2, comprising the further steps of retrieving the markup-formatted code from the computer data storage device and converting the markup-formatted code to the internal representation in computer memory.

5. The method according to claim 2, comprising the further steps of retrieving the markup-formatted code from the computer data storage device and representing the retrieved code in a corresponding graphic format on a computer display.

6. The method according to claim 5, wherein the display of the markupformatted code is facilitated by a browser.

7. The method according to claim 2, wherein the markup language is XML.

8. The method according to claim 1, wherein the graphical programming language comprises a flowchart language.

9. The method according to claim 1, wherein the graphical programming language comprises a ladder logic language.

10. The method according to claim 1, wherein the graphical programming language comprises a function block diagram language.

11. The method according to claim 1, wherein the graphical programming language comprises a sequential function chart.

12. The method according to claim 7, wherein the graphical programming language comprises a flowchart language.

13. The method according to claim 7, wherein the graphical programming language comprises a ladder logic language.

14. The method according to claim 7, wherein the graphical programming language comprises a sequential function chart.

15. The method according to claim 7, wherein the graphical programming language comprises a sequential function block diagram language.

16. The method according to claim 1, wherein the graphical programming language tool comprises an editor and the conversion is triggered by invoking an editor command.

17. The method according to claim 7, comprising the further steps of retrieving the markup-formatted code from the computer data storage device and representing the retrieved code in a corresponding graphic format on a computer display.

18. The method according to claim 17, wherein the step of displaying the code on a computer display device comprises the step of displaying the code with the use of a browser.

19. A computer program product, for use in conjunction with a computing device, for creating industrial automation system control program code using a graphical language programming tool and storing the code in a computer memory in an internal representation during execution, the computer program product comprising a computer usable medium, the computer usable medium comprising:
computer readable program code for identifying industrial automation control program code stored in computer memory in the internal representation;
computer readable program code for converting the identified industrial automation control program code from the internal representation to a markup language format.

20. The computer program product according to claim 19, the computer usable medium further comprising computer readable program code for causing the converted, markup-formatted code to be stored in a computer data storage device.

21. The computer program product according to claim 20, the computer usable medium further comprising computer readable program code for causing retrieval of the markup-formatted code from the computer data storage device and converting the markup-formatted code to the internal representation in computer memory.

22. The computer program product according to claim 19, the computer usable medium further comprising computer readable program code for causing the transmission of markup-formatted code over a network to a receiving computing device.

23. The computer program product according to claim 20, the computer program product further comprising computer readable program code for retrieving the markup-formatted code from the computer data storage device and representing the retrieved code in a corresponding graphic format on a computer display.

24. The computer program product according to claim 23, wherein the display of the markup-formatted code is facilitated by a browser.

25. The computer program product according to claim 19, wherein the markup language is XML.

26. The computer program product according to claim 19, wherein the graphical programming language comprises a flowchart language.

27. The computer program product according to claim 19, wherein the graphical programming language comprises ladder logic.

28. The computer program product according to claim 19, wherein the graphical programming language comprises function block diagrams.

29. The computer program product according to claim 19, wherein the graphical programming language comprises a sequential function chart.

30. The computer program product according to claim 25, wherein the graphical programming language comprises a flowchart language.

31. The computer program product according to claim 25, wherein the graphical programming language comprises a ladder logic language.

32. The computer program product according to claim 25, wherein the graphical programming language comprises a function block diagram language.

33. The computer program product according to claim 25, wherein the graphical programming language comprises a sequential function chart.

34. The computer program product according to claim 19, further comprising computer readable program code for converting the markup-formatted code to the graphical programming language internal representation.

35. The computer program product according to claim 19, wherein the computer program product graphical language programming tool comprises an editor, and wherein the conversion is triggered by invoking an editor command in the graphical programming language editor.

36. A computer program product comprising a computer-readable storage medium and having data stored thereon, the data comprising a representation of industrial automation control code formatted in a markup language.

37. The computer program product according to claim 36, wherein the markup language is XML.

38. The computer program product according to claim 36, wherein the computer program product is coupled to a computing system that is remotely located from an industrial automation control system.

39. A computer program product for permitting a user to create industrial automation control programs, the product comprising a computer-readable storage medium having computer program code stored on it, the code comprising:
industrial automation graphical programming language code, the graphical programming language code comprising an editor adapted to permit the user to create industrial automation control code using graphical elements, the control code being stored in memory in an internal representation during execution; and
computer program code for converting industrial automation control code, stored in memory in the internal representation, from the internal representation to a markup language format.

40. The computer program product according to claim 39, further comprising computer program code for converting industrial automation control code from the markup language format to the internal representation.

41. A method for communicating the logical structure of industrial automation control program data in order to permit a plurality of application developers to create applications relating to the data, the method comprising the steps of:
creating a schema defining a content model for markup language files generated by an industrial automation control program system; and
posting the schema for access over a network by the application developers.

42. The method according to claim 41, wherein the schema is an XML schema.

43. The method according to claim 41, wherein the industrial automation control program data comprises flowchart programming instructions.

44. A method for providing industrial automation control code from a server system, over a network to which the server system is coupled, and to a client system also coupled to the network, the method comprising the steps of:
accessing a markup-formatted version of the control code;
transmitting the accessed, markup-formatted control code over the network in connection with a network address corresponding to the client system, thereby causing the transmitted, markup-formatted control code to be received by the client system.

45. The method according to claim 44, wherein the client device, in response to the received markup-formatted control code, has transmitted to the server system data relating to the automation to which the markup-formatted control code is directed, and, further, wherein the server system has access to control code modified in response to receipt of the data from the client system, and wherein the modified control code is markup-formatted, the method comprising the further step of:
transmitting the markup-formatted, modified control code over the network in connection with a network address corresponding to the client system, thereby causing the transmitted, modified, markup-formatted control code to be received by the client system.

46. The method according to claim 45, wherein the step of transmitting the accessed, markup-formatted control code over the network comprises sending an electronic mail message.

47. The method according to claim 45, wherein the step of transmitting the accessed, markup-formatted control code over the network comprises transmitting the code over the network via hypertext transfer protocol.

48. The method according to claim 44, wherein the markup-format of the control code comprises XML.

49. The method according to claim 44, wherein a second client system is coupled to the network, the method further comprising the step of:
transmitting the accessed, markup-formatted control code over the network in connection with a network address corresponding to the second client system, thereby causing the transmitted, markup-formatted control code to be received by the second client system.

50. The method according to claim 49, wherein the first client system is configured to reconvert the markup-formatted control code to a first internal representation, and wherein the second client system is coupled to the network, the second client configured to reconvert the markup-formatted control code to a second internal representation.

51. A method for programming industrial automation control applications comprising the steps of:
providing a computer system coupled to a network;
configuring the first computer system to receive over the network transmissions of data from a plurality of industrial automation program developer systems; and
receiving data from the plurality of industrial automation program developer systems program code in a markup language format.

52. The method according to claim 51, wherein the markup language is XML.
